(19) United States
(12) Patent Application Publication
(10) Pub. No.: US 2023/0069255 A1
(43) Pub. Date: Mar. 2, 2023

(54) CONTENT DISTRIBUTION SYSTEM, CONTENT DISTRIBUTION METHOD, AND INTEGRATED MONITORING DEVICE

(71) Applicant: Mitsubishi Electric Corporation, Tokyo (JP)

(72) Inventors: Shinichi USUI, Tokyo (JP); Koichi ORITO, Tokyo (JP)

(73) Assignee: Mitsubishi Electric Corporation, Tokyo (JP)

(21) Appl. No.: 17/799,924

(22) PCT Filed: Apr. 21, 2020
(86) PCT No.: PCT/JP2020/017245

§ 371 Date: Aug. 16, 2022

(51) Int. Cl. G06F 3/14

(52) U.S. Cl. CPC G06F 3/14; H04B 5/0031

(57) ABSTRACT

A content distribution system includes: external display terminals; displays; an integrated monitoring device that generates content to be provided to an external display terminal among the plurality of external display terminals when the external display terminal is connected to a display among the displays; and an AP that transmits the content to the external display terminal through wireless communication. When the external display terminal is brought toward the display to a point at a specific distance from the display, the external display terminal transmits terminal attribute information to the display through wireless communication, the display transmits device attribute information and the terminal attribute information, to the integrated monitoring device, the integrated monitoring device generates the content corresponding to the device attribute information and the terminal attribute information, and the external display terminal displays the content.

### FIELD

The present disclosure relates to a content distribution system and a content distribution method for distributing content to an external display terminal.

### BACKGROUND

Among content distribution systems is a system including a display and an external display terminal connected to the display through near field communication for displaying information acquired by the display. The display is a device that displays a state of a control device such as a programmable logic controller (PLC) and transmits various instructions to the control device.

In such a content distribution system, a user can perform various settings on the display by operating the external display terminal. When an electronic device of the system described in Patent Literature 1 enters an area that enables communication with another electronic device, the electronic device automatically performs near field communication with the other electronic device, thereby receiving setting information from the other electronic device, and changing the setting of the electronic device on the basis of the setting information.

### CITATION LIST

### Patent Literature

Patent Literature 1: Japanese Patent Application Laid-open No. 2015-076775

### SUMMARY

### Technical Problem

Consider that the technique of Patent Literature 1 is applied to a content distribution system. In that case, when an external display terminal enters an area that enables communication with a display, the external display terminal automatically performs near field communication with the display and receives content from the display.

In the presence of a plurality of displays that transmit content, the external display terminal may unfortunately experience a problem of performing near field communication with an unintended display, and receiving undesired content from the unintended display.

The present disclosure has been made in view of the above, and an object thereof is to obtain a content distribution system that enables an external display terminal to acquire desired content.

### Solution to Problem

In order to solve the above problem and achieve the object, a content distribution system of the present disclosure comprises: a plurality of external display terminals to display first information received through wireless communication; and a plurality of interface devices to receive second information transmitted from the external display terminals and transmit the second information to an external device. The content distribution system of the present disclosure also comprises: an integrated monitoring device to monitor and control the plurality of interface devices and to generate content to be provided to a first external display terminal among the plurality of external display terminals when the first external display terminal is connected to a first interface device among the plurality of interface devices; and an access point to transmit the content to the first external display terminal through wireless communication. When the first external display terminal is brought toward the first interface device to a point at a specific distance from the first interface device, the first external display terminal transmits terminal attribute information to the first interface device through wireless communication, the terminal attribute information enabling identification of the first external display terminal. The first interface device transmits device attribute information and the terminal attribute information to the integrated monitoring device, the device attribute information enabling identification of the first interface device. The integrated monitoring device generates the content corresponding to the device attribute information and the terminal attribute information, and the external display terminals display the content.

### Advantageous Effects of Invention

The content distribution system according to the present disclosure achieves an effect of enabling the external display terminal to acquire the desired content.

### BRIEF DESCRIPTION OF DRAWINGS

FIG. 1 is a diagram illustrating a schematic configuration of a content distribution system according to an embodiment.

FIG. 2 is a diagram illustrating internal configurations of components included in the content distribution system according to the embodiment.

FIG. 3 is a flowchart illustrating a content distribution processing procedure in the content distribution system according to the embodiment.

FIG. 4 is a diagram illustrating a configuration of associated relationship information used by an integrated monitoring device according to the embodiment.

FIG. 5 is a diagram illustrating a hardware configuration that realizes the integrated monitoring device according to the embodiment.

### DESCRIPTION OF EMBODIMENTS

A content distribution system and a content distribution method according to an embodiment of the present disclosure will be hereinafter described in detail with reference to the drawings.

### Embodiment

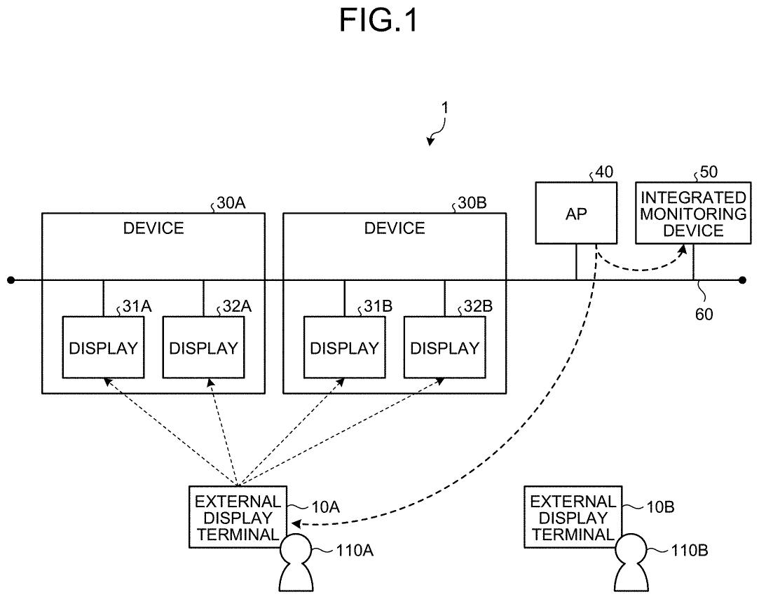

FIG. 1 is a diagram illustrating a schematic configuration of a content distribution system according to an embodiment. A content distribution system 1 includes an access point (AP) 40 and an integrated monitoring device 50. In addition, the content distribution system 1 includes a plurality of devices and a plurality of external display terminals. With reference to FIG. 1, a description will be made as to the content distribution system 1 including devices 30A and 30B and external display terminals 10A and 10B. Examples of the devices 30A and 30B include a printing device, a label creating device, a label attaching device, a boiler, a pump, and an elevator.

The device 30A includes displays 31A and 32A, and the device 30B includes displays 31B and 32B. The displays 31A, 32A, 31B, and 32B are connected to a network 60 such as Ethernet (registered trademark). The integrated monitoring device 50 and the AP 40 are connected to the network 60. In the following description, the displays 31A, 32A, 31B, and 32B may be referred to as displays 31X. The external display terminals 10A and 10B may be referred to as external display terminals 10X.

The external display terminals 10X are each a terminal capable of wirelessly communicating with various devices, and display information received through the wireless communication. The information displayed by each external display terminal 10X is first information. Examples of the external display terminal 10X include a tablet terminal and a smartphone. The embodiment will be described on the assumption that the external display terminal 10A is operated by a user 110A, and the external display terminal 10B is operated by a user 110B. Since the external display terminals 10A and 10B have configurations similar to each other, a configuration of the external display terminal 10A will be described hereinbelow. In the following description, the users 110A and 110B may be referred to as users 110X.

The external display terminal 10A has a function of performing near field communication (NFC) with the displays 31X. When the user 110A holds the external display terminal 10A over any one of the displays 31A, 32A, 31B, and 32B, the external display terminal 10A performs pairing with the display over which the user holds the external display terminal 10A. For example, when the user 110A holds the external display terminal 10A which is a first external display terminal, over the display 31A which is a first display, the external display terminal 10A performs pairing with the display 31A.

When performing pairing with the display 31A, the external display terminal 10A transmits terminal attribute information to the display 31A, and receives display attribute information from the display 31A. The terminal attribute information indicates attributes of the external display terminal 10A. The display attribute information indicates information on attributes of the display 31A. The terminal attribute information is information which enables identification of the external display terminal 10A, and the display attribute information is information which enables identification of the display 31A.

The pairing performed by the external display terminal 10A with the display 31A is NFC pairing. Examples of the terminal attribute information and the display attribute information include an internet protocol (IP) address, and a uniform resource locator (URL). The display attribute information may be information indicating locations where the displays 31X are installed. The terminal attribute information may be user authentication information which is information for identifying the users 110X.

The external display terminal 10A receives content from the integrated monitoring device 50 via the AP 40. An example of the content is an operation screen displayed by the external display terminal 10A. The operation screen is a screen for operating the display 31A on the external display terminal 10A. Arranged on the operation screen are, for example, a start button for causing the display 31A to start a specific process, an end button for causing the display 31A to end a specific process, etc. The content may be, for example, a graph indicating a state of an external device (not illustrated) of the display 31A. An example of the external device is a control device such as a PLC.

When receiving, from the user 110A, an operation for the content, the external display terminal 10A transmits, via the AP 40 to the integrated monitoring device 50, operation information which is information corresponding to that operation. The operation information is information for operating the display 31A.

The external display terminal 10A wirelessly communicates with the AP 40. The external display terminal 10A therefore receives the content from the AP 40 through wireless communication, and transmits the operation information to the AP 40 through wireless communication.

Each of the displays 31A, 32A, 31B, and 32B is connected to an external device such as a control device via the network 60. An example of the displays 31A, 32A, 31B, and 32B is a programmable display. Each of the control devices connected to the displays 31A, 32A, 31B, and 32B controls a robot, a robot peripheral device, and the like.

Since the displays 31A, 32A, 31B, and 32B have configuration similar to each other, a configuration of the display 31A will be described hereinbelow. The display 31A has a function of performing near field communication with the external display terminals 10X. A description will be hereinafter made as to the display 31A performing near field communication with the external display terminal 10A.

When performing pairing with the external display terminal 10A, the display 31A transmits the display attribute information to the external display terminal 10A, and receives the terminal attribute information from the external display terminal 10A. The terminal attribute information received by the display 31A from the external display terminal 10A is second information. The display 31A generates associated attribute information in which the terminal attribute information of the external display terminal 10A and the display attribute information of the display 31A are associated with each other.

The display 31A transmits the generated associated attribute information to the integrated monitoring device 50 via the network 60. The display 31A may transmit the associated attribute information to the integrated monitoring device 50 through wireless communication, in which case, the display 31A and the integrated monitoring device 50 may not be connected to the network 60.

The display 31A displays a state of the control device connected thereto. In addition, the display 31A may display information on the display 31A, information on the pairing, etc. An example of the information on the display 31A is display attribute information, and the information on the pairing is terminal attribute information on the external display terminal 10A.

Furthermore, the display 31A transmits, to the control device, a command corresponding to an instruction transmitted from the integrated monitoring device 50. Note that the displays 31X may not have a display function. In a case where the displays 31X do not have a display function, the displays 31X are each a human machine interface (HMI) unit, that is, an interface device. The HMI units receive information such as terminal attribute information from the external display terminals 10X and transmit and receive information to and from the control devices. In a case where interface devices are applied instead of the displays 31X, the interface devices each generate associated attribute information in which device attribute information indicating attributes of the interface device and the terminal attribute information are associated with each other. The device attribute information is information which enables identification of the interface device. In a case where the interface devices are applied instead of the displays 31X, the display 31A is a first interface device in the embodiment.

The AP 40 transmits the content transmitted from the integrated monitoring device 50, to the external display terminal 10A through wireless communication such as Wi-Fi (registered trademark).

The integrated monitoring device 50 is a computer that integrally monitors the displays 31X. When receiving the associated attribute information, the integrated monitoring device 50 generates content corresponding to the associated attribute information. In a case where the associated attribute information includes the display attribute information on the display 31A and the terminal attribute information on the external display terminal 10A, the integrated monitoring device 50 generates content corresponding to the display 31A and the external display terminal 10A.

The integrated monitoring device 50 transmits the generated content to the external display terminal 10X corresponding to the terminal attribute information. In a case where the associated attribute information includes the terminal attribute information on the external display terminal 10A, the integrated monitoring device 50 transmits the generated content to the external display terminal 10A. In that case, the integrated monitoring device 50 transmits the generated content to the external display terminal 10A via the network 60 and the AP 40.

In addition, when a user performs an operation on the display 31A, using the external display terminal 10A, the integrated monitoring device 50 receives that operation via the AP 40 and the network 60. The integrated monitoring device 50 transmits an instruction corresponding to the received operation, to the display 31A.

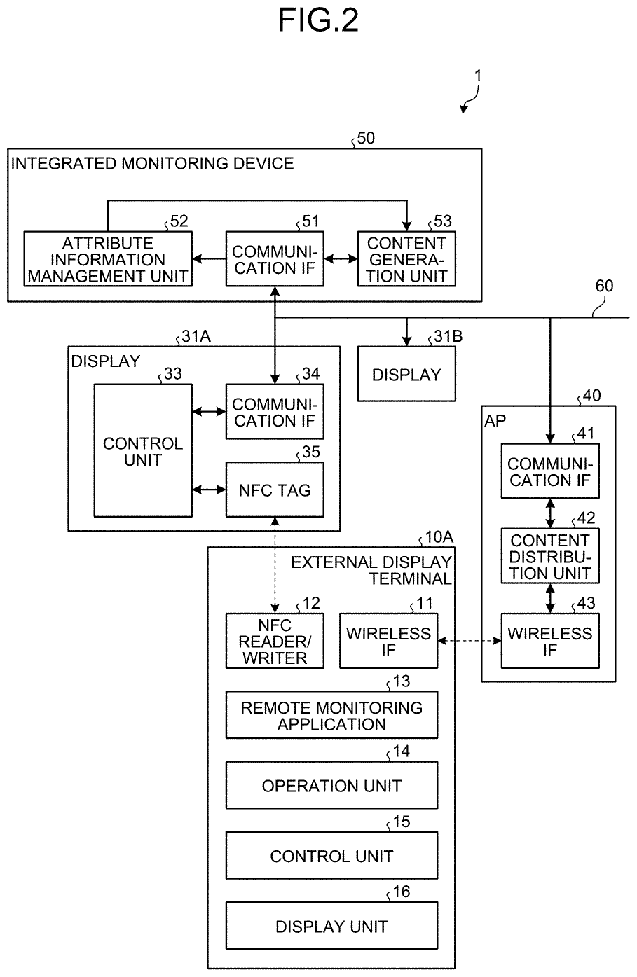

FIG. 2 is a diagram illustrating internal configurations of components included in the content distribution system according to the embodiment. FIG. 2 illustrates internal configurations of the integrated monitoring device 50, the display 31A, the external display terminal 10A, and the AP 40.

The integrated monitoring device 50 includes a communication interface (IF) 51, an attribute information management unit 52, and a content generation unit 53. The AP 40 includes a communication IF 41, a content distribution unit 42, and a wireless IF 43.

The display 31A includes an NFC tag 35, a control unit 33, and a communication IF 34. The NFC tag 35 is a near field communication tag. The external display terminal 10A includes a wireless IF 11, an NFC reader/writer 12, a remote monitoring application 13, an operation unit 14, a control unit 15, and a display unit 16. The NFC reader/writer 12 is a near field communication reader/writer.

The communication IF 51 of the integrated monitoring device 50, the communication IF 34 of the display 31A, and the communication IF 41 of the AP 40 are connected to the network 60. The communication IF 51, the communication IF 34, and the communication IF 41 can communicate with each other via the network 60.

The NFC reader/writer 12 of the external display terminal 10A reads and writes data from and to the NFC tag 35 of the display 31A. The wireless IF 11 of the external display terminal 10A can wirelessly communicate with the wireless IF 43 of the AP 40.

The remote monitoring application 13 of the external display terminal 10A is an application for displaying content transmitted from the integrated monitoring device 50. The remote monitoring application 13 is implemented by a virtual network computing (VNC) client function or a web client function.

The operation unit 14 receives an operation from the user 110A. Note that the external display terminal 10A may not include the operation unit 14. The content in that case is, for example, information indicating a state of the control device connected to the external display terminal 10A. The display unit 16 displays the content transmitted from the integrated monitoring device 50. The display unit 16 displays the content under the control of the remote monitoring application 13. The control unit 15 controls each component of the external display terminal 10A.

The control unit 33 of the display 31A controls the components of the display 31A. The control unit 33 writes the display attribute information on the display 31A, to the NFC tag 35. When receiving an instruction to respond to a user operation, from the integrated monitoring device 50 via the communication IF 34, the control unit 33 executes a process corresponding to that instruction. The control unit 33 may have a screen generation function of generating screen data on a screen to be displayed by an external device. Examples of the screen generation function include a VNC client function and a web client function.

Although the display 31A may include a display unit, the display unit is not illustrated in FIG. 2. In a case where the display 31A includes a display unit, the display unit displays information on pairing, etc. In addition, the display 31A may include an operation unit that receives an operation from the user 110A.

The attribute information management unit 52 of the integrated monitoring device 50 stores associated relationship information (associated relationship information 70 to be described later) in which the terminal attribute information, the display attribute information, and identification information on the content are associated with each other. In addition, the attribute information management unit 52 receives the associated attribute information transmitted from the displays 31X via the communication IF 51. On the basis of the associated attribute information and the associated relationship information 70, the attribute information management unit 52 determines content to be generated by the content generation unit 53.

The content generation unit 53 receives, from the display 31B via the communication IF 51, information on screen data used in generating the screen data. Using the information on the screen data, the content generation unit 53 generates the content determined by the attribute information management unit 52. The content generated by the content generation unit 53 is content corresponding to the terminal attribute information and the display attribute information which are included in the associated attribute information. The content generation unit 53 transmits the generated content to the AP 40 via the communication IF 51 and the network 60.

The content distribution unit 42 of the AP 40 distributes the content generated by the integrated monitoring device 50, to the external display terminal 10A. Specifically, when the communication IF 41 receives the content, the content distribution unit 42 transmits the content from the wireless IF 43 to the external display terminal 10A. That is, the content distribution unit 42 relays the content generated by the integrated monitoring device 50, to the external display terminal 10A.

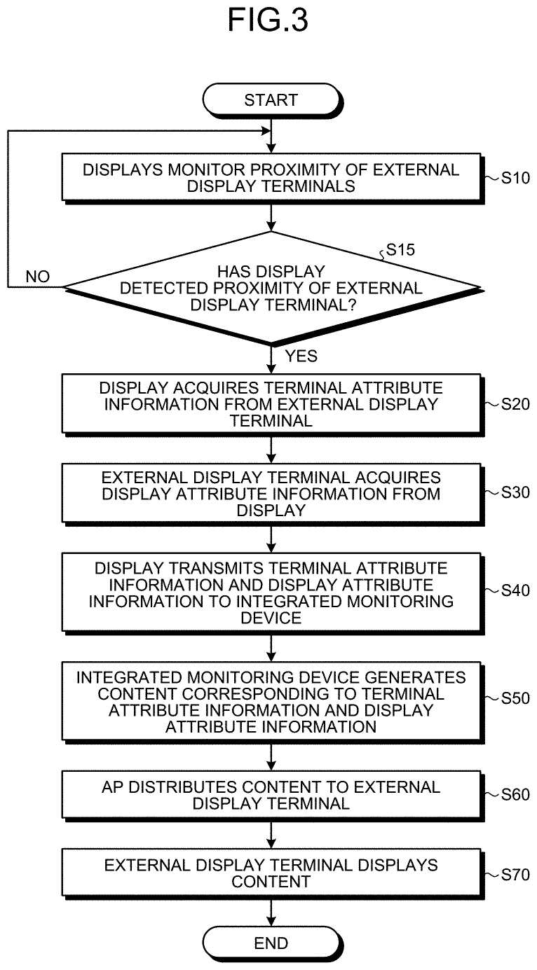

FIG. 3 is a flowchart illustrating a content distribution processing procedure in the content distribution system according to the embodiment. In the content distribution system 1, the displays 31A, 32A, 31B, and 32B monitor the proximity of the external display terminals 10A and 10B (step S10). A description will be herein made as to an example where the external display terminal 10A is held over the display 31A in proximity to the display 31A.

The control unit 33 of the display 31A monitors the proximity of the external display terminal 10A by monitoring a state of the NFC tag 35. The control unit 33 of the display 31A determines whether the external display terminal 10A is in proximity thereto on the basis of whether power has been supplied to the NFC tag 35 by the external display terminal 10A.

If the display 31A has not detected the proximity of the external display terminal 10A (step S15, No), the display 31A returns to step S10 and monitors the proximity of the external display terminal 10A.

When the external display terminal 10A is held over the display 31A, the NFC reader/writer 12 supplies power to the NFC tag 35 of the display 31A with electromagnetic waves. If the display 31A has detected the proximity of the external display terminal 10A (step S15, Yes), the display 31A acquires the terminal attribute information from the external display terminal 10A (step S20). That is, when the control unit 33 of the display 31A detects the proximity of the external display terminal 10A on the basis of the presence or absence of power supply to the NFC tag 35, the NFC reader/writer 12 writes the terminal attribute information to the NFC tag 35.

The external display terminal 10A acquires the display attribute information from the display 31A (step S30). Specifically, the NFC reader/writer 12 reads the display attribute information written to the NFC tag 35. The display unit 16 of the external display terminal 10A displays the display attribute information. Consequently, the user 110A can check to which display the external display terminal 10A is connected. If the content, which the external display terminal 10A thereafter acquires the from the integrated monitoring device 50, includes the display attribute information, the external display terminal 10A can check whether there is a discrepancy with the display attribute information acquired by the external display terminal 10A.

The display 31A transmits the terminal attribute information and the display attribute information to the integrated monitoring device 50 (step S40). That is, the display 31A transmits the associated attribute information to the integrated monitoring device 50.

The integrated monitoring device 50 generates content corresponding to the terminal attribute information and the display attribute information (step S50). Specifically, on the basis of the terminal attribute information, the display attribute information, and the associated relationship information 70, the attribute information management unit 52 determines which content is transmitted to which external display terminal 10X. The attribute information management unit 52 determines content to be transmitted to the external display terminal 10A.

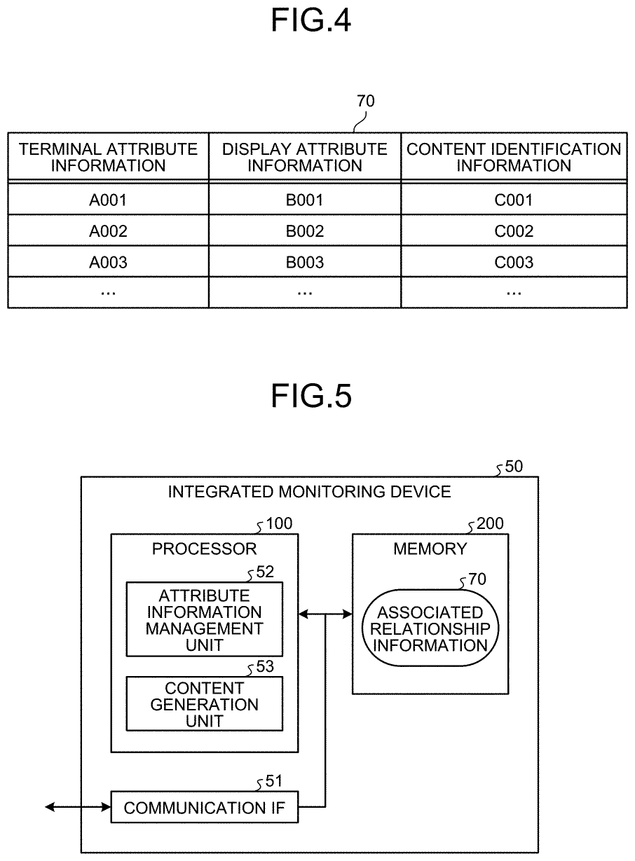

FIG. 4 is a diagram illustrating a configuration of associated relationship information used by the integrated monitoring device according to the embodiment. In the associated relationship information 70, terminal attribute information which is identification information of the external display terminals 10X, display attribute information which is identification information of the displays 31A, 32A, 31B, and 32B, and content identification information which is identification information of content are associated with each other. On the basis of the associated relationship information 70, the attribute information management unit 52 determines the content identification information corresponding to the terminal attribute information and the display attribute information from the display 31A.

On the basis of the content identification information, the content generation unit 53 generates content corresponding to the terminal attribute information and the display attribute information. The content generation unit 53 transmits the generated content to the AP 40 via the communication IF 51 and the network 60.

The AP 40 distributes the content to the external display terminal 10A (step S60). Specifically, the communication IF 41 of the AP 40 receives the content via the network 60 and transmits the content to the content distribution unit 42. The content distribution unit 42 transmits a content distribution command to the wireless IF 43. The content distribution command includes the content and the address of the display 31A. The wireless IF 43 transmits the content to the external display terminal 10A through wireless communication.

Consequently, the wireless IF 11 of the external display terminal 10A receives the content. The external display terminal 10A displays the received content (step S70). Specifically, the content is displayed by the remote monitoring application 13 and the display unit 16 of the external display terminal 10A.

Thereafter, when an operation is performed by the user 110A on the content of the external display terminal 10A, the external display terminal 10A transmits operation information which is information corresponding to that operation, to the integrated monitoring device 50 via the AP 40. Consequently, the integrated monitoring device 50 transmits, to the display 31A, an instruction corresponding to the operation information. The display 31A operates in accordance with the instruction from the integrated monitoring device 50. When the display 31A transmits an instruction to the control device, a state of the control device changes. With the display 31A displaying the state of the control device, the user 110 A can perform an operation on the external display terminal 10A, depending on the state of the control device.

When the user 110A holds the external display terminal 10A over a display other than the display 31A (for example, the display 31B), pairing between the external display terminal 10A and the display 31A is canceled, and pairing is performed between the external display terminal 10A and the display 31B. Thereafter, in the content distribution system 1, processes similar to the processes described with reference to FIG. 3 are executed. That is, the integrated monitoring device 50 generates content corresponding to the terminal attribute information on the external display terminal 10A and the display attribute information on the display 31B, and the content is distributed from the AP 40 to the external display terminal 10A.

As described above, in the content distribution system 1, since the external display terminals 10X each include the NFC reader/writer 12 and the displays 31X each include the NFC tag 35, the displays 31X can acquire the terminal attribute information from the external display terminals 10X. Consequently, the displays 31X transmit, to the integrated monitoring device 50, the associated attribute information in which the terminal attribute information and the display attribute information are associated with each other, so that, on the basis of the associated attribute information, the integrated monitoring device 50 can determine which external display terminal 10X remotely monitors which display 31X. The integrated monitoring device 50 can therefore generate content corresponding to the associated attribute information.

In addition, in the content distribution system 1, since paring between the displays 31X and the external display terminals 10X is performed uniquely on the basis of the associated attribute information, the integrated monitoring device 50 can specify content correctly associated with the displays 31X on the basis of the associated attribute information. That is, the integrated monitoring device 50 can generate and transmit the content of the displays 31X remotely monitored by the external display terminals 10X. Consequently, each of the external display terminals 10X can display the content corresponding to the display 31X paired therewith and can receive an operation on the display 31X.

Meanwhile, there is a content distribution system that performs pairing between an external display terminal and a display without using associated attribute information, and allows the external display terminal to acquire content from the display paired therewith. For such a content distribution system, the external display terminal may perform pairing with another display with which the external display terminal does not desire to pair. In that case, the external display terminal acquires content corresponding to that undesirable display, and a user of the external display terminal may rewrite unintended information or perform an erroneous operation.

On the other hand, in the content distribution system 1 of the embodiment, the integrated monitoring device 50 generates content using the associated attribute information at a time of pairing of the external display terminals 10X and the displays 31X, so that the external display terminals 10X can accurately acquire desired content.

Note that, in the content distribution system 1, the displays 31X may generate a part of content. At least one of the displays 31X may include the integrated monitoring device 50. At least one of the displays 31X may have the function of the AP 40.

The content distribution system 1 may enable pairing between the displays 31X and the external display terminals 10X only while the external display terminals 10X are held over the displays 31X. In that case, the external display terminals 10X each measure a distance to the display 31X, and the pairing with the external display terminal 10X is disabled when the measured distance exceeds a threshold. For example, when an area where the external display terminals 10X can be held over the displays 31X is a safety area, the users 110X can perform operations on the displays 31X via the external display terminals 10X in the safety area.

The displays 31X may be permitted to pair only with the external display terminals 10X that have been registered. The external display terminal 10A may be permitted to pair only with the displays 31X that have been registered.

The external display terminals 10X may request, from the integrated monitoring device 50, content designated by the operations of the users 110X.

A hardware configuration of the integrated monitoring device 50 will be described. FIG. 5 is a diagram illustrating a hardware configuration that realizes the integrated monitoring device according to the embodiment. The integrated monitoring device 50 can be realized by a processor 100, a memory 200, and the communication IF 51. Examples of the processor 100 include a central processing unit (CPU, also referred to as a processing device, an arithmetic device, a microprocessor, a microcomputer, or a digital signal processor (DSP)), and system large scale integration (LSI). Examples of the memory 200 include a random access memory (RAM) and a read only memory (ROM).

The integrated monitoring device 50 is realized by the processor 100 reading and executing a computer-executable information processing program stored in the memory 200 for performing an operation of the integrated monitoring device 50. It can also be said that the information processing program, which is a program for performing an operation of the integrated monitoring device 50, causes a computer to execute a procedure or a method of the integrated monitoring device 50.

The information processing program executed by the integrated monitoring device 50 has a modular configuration including the attribute information management unit 52 and the content generation unit 53, and these are loaded on a main storage device and generated on the main storage device.

The communication IF 51 receives associated attribute information and transmits the associated attribute information to the processor 100. The memory 200 is used as a temporary memory when the processor 100 executes various processes. The memory 200 stores associated attribute information, the associated relationship information 70, content, and the like. The communication IF 51 outputs generated content to the network 60.

The information processing program may be stored in a computer-readable storage medium as a file in an installable format or an executable format and provided as a computer program product. The information processing program may be provided to the integrated monitoring device 50 via a network such as the Internet. A part of the functions of the integrated monitoring device 50 may be implemented by dedicated hardware such as a dedicated circuit and another part thereof may be implemented by software or firmware. The displays 31X, the external display terminals 10X, and the AP 40 can also be implemented by a hardware configuration similar to that of the integrated monitoring device 50.

As described above, in the embodiment, when the external display terminal 10A is brought toward the display 31A to a point at a specific distance from the display 31A, the external display terminal 10A transmits the terminal attribute information to the display 31A through wireless communication. The display 31A transmits the display attribute information and the terminal attribute information to the integrated monitoring device 50, the integrated monitoring device 50 generates content corresponding to the display attribute information and the terminal attribute information, and the external display terminal 10A displays the content. Consequently, the content distribution system 1 can prevent erroneous content from being provided to the external display terminal 10A. In the content distribution system 1, therefore, the external display terminal 10A can acquire desired content.

The configurations described in the embodiment above are merely examples and can be combined with other known technology and part thereof can be omitted or modified without departing from the gist thereof.

### REFERENCE SIGNS LIST

1 content distribution system; 10A, 10B external display terminal; 11, 43 wireless IF; 12 NFC reader/writer; 13 remote monitoring application; 14 operation unit; 15, 33 control unit; 16 display unit; 30A, 30B device; 31A, 32A, 31B, 32B display; 34, 41, 51 communication IF; 35 NFC tag; 40 AP; 42 content distribution unit; 50 integrated monitoring device; 52 attribute information management unit; 53 content generation unit; 60 network; 70 associated relationship information; 100 processor; 110A, 110B user; 200 memory.

1. A content distribution system comprising:
a plurality of external display terminals to display display-information received through wireless communication;
a plurality of interface circuits to receive terminal attribute information, the terminal attribute information being information transmitted from the external display terminals and enabling identification of the external display terminals;
integrated monitoring circuitry to monitor and control the plurality of interface circuits and to generate content to be provided to a first external display terminal among the plurality of external display terminals when the first external display terminal is connected to a first interface circuit among the plurality of interface circuits; and
access point circuitry to transmit the content to the first external display terminal through wireless communication, wherein
when the first external display terminal is brought toward the first interface circuit to a point at a specific distance from the first interface circuit, the first external display terminal transmits the terminal attribute information to the first interface circuit through wireless communication,
the first interface circuit transmits circuit attribute information and the terminal attribute information to the integrated monitoring circuitry, the circuit attribute information enabling identification of the first interface circuit,
the integrated monitoring circuitry generates the content corresponding to the circuit attribute information and the terminal attribute information, and
the first external display terminal display the content.

2. The content distribution system according to claim 1, wherein
the plurality of interface circuits, the integrated monitoring circuitry, and the access point circuitry are connected to one another by a network,
the first interface circuit transmits the circuit attribute information and the terminal attribute information to the integrated monitoring circuitry via the network, and
the integrated monitoring circuitry transmits the content to the access point circuitry via the network.

3. The content distribution system according to claim 2, wherein
the content is an operation screen for the first interface circuit,
when the operation screen is operated, the first external display terminal transmits operation information to the access point through wireless communication, the operation information indicating information on the operation of the operation screen, and
the access point circuitry transmits the operation information to the integrated monitoring circuitry via the network, and the integrated monitoring circuitry transmits a command corresponding to the operation information, to the first interface device circuit via the network.

4. The content distribution system according to claim 1, wherein
the first interface circuit includes a near field communication tag to store the circuit attribute information,
the first external display terminal includes a near field communication reader/writer to write the terminal attribute information to the near field communication tag and read the circuit attribute information from the near field communication tag, and
when the first external display terminal is brought toward the first interface circuit to a point at a specific distance from the first interface circuit, the first interface circuit and the first external display terminal are connected by near field communication pairing.

5. The content distribution system according to claim 4, wherein
the near field communication pairing between the first external display terminal and the first interface circuit is enabled only while the first external display terminal is brought toward the first interface circuit to a point at a specific distance from the first interface circuit.

6. A content distribution method comprising:
connecting a first external display terminal and a first interface circuit to each other, the first external display terminal being among a plurality of external display terminals to display display-information received through wireless communication, the first interface circuit being among a plurality of interface circuits to receive terminal attribute information, the terminal attribute information being information transmitted from any of the external display terminals and enabling identification of the external display terminals;
generating content to be provided to the first external display terminal;
transmitting the content to the first external display terminal through wireless communication; and
displaying the content, wherein
connecting the first external display terminal and the first interface circuit to each other includes:
transmitting the terminal attribute information from the first external display terminal to the first interface circuit through wireless communication when the first external display terminal is brought toward the first interface circuit to a point at a specific distance from the first interface circuit; and
transmitting circuit attribute information and the terminal attribute information from the first interface device to integrated monitoring circuitry, the circuit attribute information enabling identification of the first interface circuit, and wherein
generating the content includes generating, at the integrated monitoring circuitry, the content corresponding to the circuit attribute information and the terminal attribute information.

7. The content distribution system according to claim 2, wherein
the first interface circuit includes a near field communication tag to store the circuit attribute information,
the first external display terminal includes a near field communication reader/writer to write the terminal attribute information to the near field communication tag and read the circuit attribute information from the near field communication tag, and
when the first external display terminal is brought toward the first interface circuit to a point at a specific distance from the first interface circuit, the first interface circuit and the first external display terminal are connected by near field communication pairing.

8. The content distribution system according to claim 3, wherein
the first interface circuit includes a near field communication tag to store the circuit attribute information,
the first external display terminal includes a near field communication reader/writer to write the terminal attribute information to the near field communication tag and read the circuit attribute information from the near field communication tag, and
when the first external display terminal is brought toward the first interface circuit to a point at a specific distance from the first interface circuit, the first interface circuit and the first external display terminal are connected by near field communication pairing.

9. An integrated monitoring device to monitor and control a plurality of interface circuits and generate content to be provided to a first external display terminal among a plurality of external display terminals when the first external display terminal is connected to a first interface circuit among the plurality of interface devices, wherein
when receiving circuit attribute information enabling identification of the first interface circuit and terminal attribute information that is information enabling identification of the first external display terminal, the integrated monitoring device generates the content corresponding to the circuit attribute information and the terminal attribute information.
